(19) United States
(12) Patent Application Publication
(10) Pub. No.: US 2025/0270375 A1
(43) Pub. Date: Aug. 28, 2025

(54) SMART DEVICE COMPONENT COMPRISING A POLYAMIDE COMPOSITION WITH LOW WATER UPTAKE

(71) Applicant: SOLVAY SPECIALTY POLYMERS USA, LLC, Alpharetta, GA (US)

(72) Inventors: Franck Touraud, Eyzin Pinet (FR); Clement Servel, Saint Just Chaleyssin (FR); Matthew Vincent, Buford, GA (US); Lindsey Mondschein, Cumming, GA (US); Stéphane Jeol, Saint-Genis-Laval (FR); Véronique Bossennec, Serezin-du-Rhône (FR)

(73) Assignee: SOLVAY SPECIALTY POLYMERS USA, LLC, Alpharetta, GA (US)

(21) Appl. No.: 18/858,659

(22) PCT Filed: Apr. 21, 2023
(86) PCT No.: PCT/EP2023/060473

§ 371 Date: Oct. 21, 2024

(30) Foreign Application Priority Data
Apr. 21, 2022 (EP) 22305589.8

(51) Int. Cl. C08J 5/04; C08K 5/00; C08K 5/098

(52) U.S. Cl. CPC C08J 5/043; C08K 5/005; C08K 5/098; C08J 2377/02; C08J 2377/06

(57) ABSTRACT

Described herein is a smart device component comprising a polyamide composition comprising at least 50% by weight (wt %) of a polyamide comprising at least 50% by mol (mol %) of recurring units of —NH—(CH2)8-C(O)— and/or —NH—(CH2)9-C(O)—; from 0 wt % to 50 wt % of at least one reinforcing agent, and from 0 wt % to 30 wt % of at least one additive, with low water uptake, high melting temperature and good dimensional stability, wherein no recurring unit of the polyamide is fully aromatic. The present invention also relates to use of the polyamide composition in manufacturing a smart device component.

This application claims priority of European patent application No. 22305589.8 filed on 21 Apr. 2022, the content of which being entirely incorporated herein by reference for all purposes. In case of any incoherency between the two applications that would affect the clarity of a term or expression, it should be made reference to the present application only.

### TECHNICAL FIELD

The present invention belongs to the field of smart devices and relates to a smart device including a least one smart device component made of or comprising a polyamide composition (PC) comprising at least 50.0% by weight (wt %) of at least one polyamide (PA), preferably bio-based, comprising at least 90.0 mol % of recurring units of —NH—(CH₂)₈—C(O)— and/or —NH—(CH₂)₉—C(O)—; from 0 wt % to 50.0 wt % of at least one reinforcing agent, and from 0 wt % to 30.0 wt % of at least one additive. The polyamide (PA) has a low water uptake, high melting temperature and good dimensional stability and no recurring unit of the polyamide (PA) is fully aromatic. The present invention also relates to use of the polyamide composition (PC) in manufacturing a smart device component.

### BACKGROUND

A polyamide is one of polymers which have been frequently used as engineering plastics for a very wide range of applications. A polyamide composition is of significant commercial interest and may be used to produce automobile or electrical components, generally by injection molding, in view of weight reduction, ease in assembling parts/components and also its design flexibility.

For certain applications, for instance, smart device components, such as mobile electronic device components; automotive components and aerospace components, which are to be exposed to high temperature during their lifecycle, required is a polyamide composition which is capable of exhibiting excellent mechanical properties after thermal aging and minimum distortion during injection molding.

In particular, due to the demand for smart devices having particular properties such as low water uptake, good mechanical properties, high thermal stability and dimensional stability with regard to moisture and temperature conditions, polyamide compositions have been widely used for this purpose.

EP 2660268 (Shanghai Genius Advanced Material Co. Ltd.) discloses a composite material comprising inorganic nano-particles and a polyamide produced by polymerization of lactam as monomer, wherein the inorganic nano-particles are uniformly dispersed in the polyamide resulting in high mechanical performance. Such a composite may be used as a structural material, a functional material and a polymer master batch, notably in the applications such as electronics, electricity, instruments, communications, etc.

WO 2019/185509 (BASF SE) discloses a polyamide composition comprising at least one polyamide, hollow glass bubbles having adhesive on at least one portion of surfaces thereof, and reinforcing fibers, resulting in high mechanical properties and high burst pressure. High burst pressure is considered to contribute to the improvement of adhesion force, notably after vibration welding without compromising haze on the surface of final articles.

“Nylon-9 from unsaturated fatty derivatives: preparation and characterization” Journal of the American Oil Chemists Society, Springer, 1975, 52 (1), 473-477, XP002545488 (D1), EP 3872116 (D2), U.S. Pat. No. 7,772,329 (D3), “Nylon-9 via 9-aminononanoic acid from soybean oil”, Industrial and Engineering chemistry product research and development, 1971, 10 (4), 442-447, ISSN: 0536-1079, DOi: 10.1021/I360040A022 (D6), “Thermal properties of amino acid type polyamides”, Chem. zvesti, 1976, 30 (3), 281-291 (D7) do not disclose a smart device nor the use in the preparation of a smart device component.

U.S. Pat. No. 9,758,673 (D4) and WO 2018229127 (D5), US 2018/0155497 (D8) do not disclose the polyamide composition (PC).

In this regard, polyamide 12 (PA12) has been most highlighted as an optimal polyamide for smart device component, thanks to its mechanical properties comparable to those of polyamide 6 (PA6) or polyamide 66 (PA66) in addition to its low water uptake. Further, the low density of PA12, i.e. about 1.01 g/mL, which results from its relatively long hydrocarbon chain, confers it good dimensional stability. PA12 is also known to be resistant to chemicals and stress cracking. Nonetheless, there exists drawback of PA12, e.g. limited thermal stability due to its relatively low melting temperature.

Thermal stability is also an advantage for physical vapor deposition (PVD), aka phase vapor deposition (PVD) or physical vapor transport (PVT), which can be used in producing thin films and coatings, notably useful for smart device components.

### Technical Problem

There is a need of a polymeric material to be used in the preparation of components of smart devices and having good thermal properties notably a melting temperature of at least 200° C.—notably for the preparation of components metallized with PVD—while still offering a compromise of physico-chemical properties such as a low water-uptake, good dimensional stability, decent mechanical properties and low dielectric constants (Dk, Df).

Moreover, there is a growing request for polymeric materials prepared from renewable feedstocks i.e. bio-based or recycled materials.

The invention aims at solving this technical problem.

### SUMMARY

The invention is as disclosed in the appended set of claims.

The invention relates to a smart device as defined in any one of claims 1-24.

The invention also relates to a smart device component as defined in any one of claims 25-26.

The invention also relates to a use as defined in claim 27 or 28.

More precisions on these subject-matters are provided herein.

### BRIEF DESCRIPTION OF THE DRAWINGS

FIG. 1 represents water uptake (in wt %) at room temperature and relative humidity (RH)=100% of PA9, PA510, PA610 and PA12.

FIG. 2 represents tensile modulus and flexural modulus (in MPa) of PA9, PA510, PA610 and PA12.

FIG. 3 represents tensile stress and strain at break (in MPa and in %) of PA9, PA510, PA610 and PA12.

FIG. 4 represents impact strength (in kJ/m²; both for notched and unnotched) of PA9, PA510, PA610 and PA12.

FIG. 5 represents dielectric properties (dielectric constant in DK, 2.45 GHz and dissipation factor in DF or loss tangent) of PA9, PA510, PA610 and PA12.

### DETAILED DESCRIPTION OF THE INVENTION

### Definitions

wt %: % by weight; mol %: % by moles.

The proportions of recurring units in the polyamide (PA) are given relative to the total moles of recurring units in the polyamide (PA).

Throughout this specification, unless the context requires otherwise, the word ‘comprise’ or ‘include’, or variations such as ‘comprises’, ‘comprising’, ‘includes’, ‘including’ will be understood to imply the inclusion of a stated element or method step or group of elements or method steps, but not the exclusion of any other element or method step or group of elements or method steps. The term ‘comprising’ includes ‘consisting essentially of’ and also ‘consisting of’. According to preferred embodiments, the word ‘comprise’ and ‘include’ and their variations mean ‘consist exclusively of’.

The term ‘between’ should be understood as being inclusive of the limits.

As used herein, the term ‘alkyl group’ denotes a radical derived from an alkane by removal of one hydrogen atom and includes saturated hydrocarbons having one or more carbon atoms, including straight and branched chains. As used herein, the them ‘alkylene’ groups denotes a divalent radical derived from an alkane by removal of an hydrogen atom from two carbon atoms.

As used herein, the terminology ‘(Cn-Cm)’ in reference to an organic group, wherein n and m are integers, respectively, indicates that the group may contain from n carbon atoms to m carbon atoms per group.

In the context of the present invention, the term ‘percent by weight’ (wt %) indicates the content of a specific component in a mixture, calculated as the ratio between the weight of the component and the total weight of the mixture. As used herein, the concentration of recurring units in ‘percent by mol’ (mol %) refers to the concentration relative to the total number of recurring units in the polyamide, unless explicitly stated otherwise.

As used herein, a ‘semi-crystalline’ polyamide exhibits a heat of fusion Hm of at least 5.0 Joules per gram (J/g) measured by differential scanning calorimetry (DSC) at a heating rate of 20° C./min. Similarly, as used herein, an “amorphous” polyamide exhibits a heat of fusion Hm of less than 5.0 J/g, preferably of less than 3.0 J/g, and more preferably of less than 2.0 J/g measured using DSC at a heating rate of 20° C./min. A heat of fusion Hm can be measured according to ASTM D3418

As used herein, when referring to ‘glass transition temperature’ (T_{g}) and ‘melting temperature’ (Tₘ) for the polyamide, T_{g} and Tₘ are preferably measured according to ASTM D3418, unless stated otherwise.

In the passages of the present specification which will follow, any description, even though described in relation to a specific embodiment, is applicable to and interchangeable with other embodiments of the present disclosure. Each embodiment thus defined may be combined with another embodiment, unless otherwise indicated or clearly incompatible. In addition, it should be understood that the elements and/or the characteristics of a composition, a product or article, a process or a use, described in the present specification, may be combined in all possible ways with the other elements and/or characteristics of the composition, product or article, process or use, explicitly or implicitly, this being done without departing from the scope of the present description.

### Smart Device of the Invention

The invention relates first to a smart device including at least one smart device component (or simply component) made of or comprising the polyamide composition (PC) as disclosed herein.

The term ‘smart device’ is intended to denote an electronic device, connected or connectable to other devices and/or networks via wireless protocols, such as WiFi, Bluetooth, 5G, etc.

The smart device generally includes at least one battery to provide the necessary power to the electronic device.

The smart device may be more particularly a mobile electronic device.

The mobile electronic device may more particularly be selected from the group consisting of a mobile electronic phone, notably a smart phone; a personal digital assistant; a laptop computer; a tablet computer; a radio; a camera; a camera accessory; a wearable computing device (e.g. a smart watch, smart glasses and the like), a calculator, a music player, a global positioning system (GPS) receiver, a portable game console and console accessories, a hard drive and an electronic storage device.

The smart glasses are usually also referred to as AR glasses (AR=Augmented Reality) or VR glasses (VR=Virtual Reality).

The mobile electronic device may more particularly be selected from the group consisting of a mobile electronic phone, notably a smart phone; a laptop computer; a tablet computer and wearable computing devices, e.g. smart watches.

The mobile electronic device may more particularly be any one of those disclosed in the lists above.

In some embodiments, the smart device is a mobile electronic device, comprising an antenna, an antenna window, an antenna housing or a mobile electronic housing.

The smart device may be more particularly a mobile electronic device comprising (i) an antenna; (ii) an antenna window (or antenna band) and/or (iii) a mobile electronic housing. It may comprise the item(s): (i) or (ii) or (iii) or (i) and (ii) or (i) and (iii) or (i), (ii) and (iii).

### Smart Device Component

The smart device comprises at least one smart device component made of or comprising the polyamide composition (PC) as defined herein, the component being notably selected in the group consisting of antenna windows, fitting parts, snap fit parts, mutually moveable parts, functional elements, operating elements, tracking elements, adjustment elements, carrier elements, frame elements, switches, connectors, cables, housings, and any other structural part other than housings as used in a mobile electronic devices, such as for example speaker parts.

In some embodiments, the mobile electronic device component may also be a mobile electronic device housing. The ‘mobile electronic device housing’ refers to one or more of the back cover, front cover, antenna housing, frame and/or backbone of a mobile electronic device. The housing may be a single article or comprise two or more components. A ‘backbone’ refers to a structural component onto which other components of the device, such as electronics, microprocessors, screens, keyboards and keypads, antennas, battery sockets, and the like are mounted. The backbone may be an interior component that is not visible or only partially visible from the exterior of the mobile electronic device. The housing may provide protection for internal components of the device from impact and contamination and/or damage from environmental agents (such as liquids, dust, and the like). Housing components such as covers may also provide substantial or primary structural support for and protection against impact of certain components having exposure to the exterior of the device such as screens and/or antennas.

In some embodiments, the mobile electronic device housing is selected from the group consisting of a mobile phone housing, an antenna housing, an antenna window, a tablet housing, a laptop computer housing, a tablet computer housing or a watch housing.

In some embodiments, the component can be a mounting component with mounting holes or other fastening device, including but not limited to, a snap fit connector between itself and another component of the mobile electronic device, including but not limited to, a circuit board, a microphone, a speaker, a display, a battery, a cover, a housing, an electrical or electronic connector, a hinge, a radio antenna, a switch, or a switchpad.

In some embodiments, the mobile electronic device component may include, for example, a radio antenna. In this case, the radio antenna can be a WiFi antenna or an radio frequency identification (RFID) antenna. In some such embodiments, at least a portion of the radio antenna is disposed on the polyamide composition (PC). Additionally or alternatively, at least a portion of the radio antenna can be displaced from the polyamide composition (PC).

The smart device component may more particularly be any one of those disclosed in the lists above.

The smart device can be molded from the polyamide composition (PC) by any process adapted to thermoplastics, e.g. extrusion, injection molding, blow molding, rotomolding, overmolding or compression molding. The process used is typically a melt-processing method such as injection molding or extrusion molding of the polyamide composition, injection molding being a preferred shaping method.

### Use of the Polyamide Composition (PC) in Manufacturing a Smart Device Component

Another aspect of the present invention provides the use of the polyamide composition (PC) as defined herein in manufacturing a smart device component, notably as defined herein.

The smart device component may more particularly be any one of those listed herein. It can be notably a housing.

### About the Polyamide Composition (PC)

The polyamide composition (PC) comprises or consists of:
at least 50.0 wt % of at least one polyamide (PA);
from 0 wt % to 50.0 wt % of at least one reinforcing agent; and
from 0 wt % to 30.0 wt % of at least one additive.

These proportions in wt % are given relative to the total weight of the polyamide composition (PC).

The polyamide composition (PC) comprises at least one polyamide (PA) as defined herein. It may comprise only one or more than one polyamide (PA) as defined herein.

The components of the polyamide composition (PC) are preferably blended together.

Details about the reinforcing agent(s) and the additive(s)—both optional as their respective proportion may independently be 0%—will now be provided.

The total proportion of the reinforcing agent(s) is between 0 and 50.0 wt %. The total proportion of the additive(s) different from the reinforcing agent is between 0 and 30.0 wt %.

The polyamide composition preferably does not comprise an aromatic polyamide. An aromatic polyamide is a polyamide comprising recurring units including an aromatic ring.

The polyamide composition preferably does not comprise an amorphous polyamide.

### Reinforcing Agent

The polyamide composition (PC) comprises at least one reinforcing filler, in an amount of from 0 wt % to 50.0 wt % relative to the total weight of polyamide composition.

The term ‘reinforcing agent’ is intended to denote a material added to a polyamide composition to improve its mechanical properties, such as rigidity, tensile strength, impact resistance and dimensional stability and/or to reduce the cost. By appropriately selecting these materials, not only the economics but also other properties such as processing and mechanical behavior can be improved. Although those reinforcing agents retain their inherent characteristics, very significant differences are often observed depending on the molecular weight, compounding technique and the presence of other additives in the formulation. Therefore, once the basic property requirements are established, the optimum type and loading level of reinforcing agent for the balance between cost and performance must be determined.

The polyamide composition (PC) comprises from 0 wt % to 50.0 wt % of at least one reinforcing agent, relative to the total weight of polyamide composition (PC).

The proportion of reinforcing agent(s) may be at least 0.1 wt %, preferably at least 1.0 wt %, preferably at least 5.0 wt %, preferably at least 10.0 wt %, more preferably at least 15.0 wt %. This proportion may be at most 50.0 wt %, preferably at most 45.0 wt %, more preferably at most 40.0 wt %, based upon the total weight of the polyamide composition.

The reinforcing agent may more particularly be selected from the group consisting of mineral fillers (e.g. talc, mica, kaolin, calcium carbonate, calcium silicate, magnesium carbonate), glass fibers, carbon fibers, synthetic polymeric fibers, aramid fibers, aluminum fibers, titanium fibers, magnesium fibers, boron carbide fibers, rock wool fibers, steel fibers, natural fibers (e.g. linen, hemp or cellulose), graphene, nano-graphene, carbon nanotube, wollastonite, glass balls (e.g. hollow glass microspheres) and any combination of two or more thereof.

The reinforcing agent may more particularly be selected from the group consisting of carbon fibers, glass fibers and combinations thereof.

Glass fibers are silica-based glass compounds that contain several metal oxides which can be tailored to create different types of glass. The main oxide is silica in the form of silica sand; the other oxides such as calcium, sodium and aluminum are incorporated to reduce the melting temperature and impede crystallization. The glass fibers may be endless fibers or chopped glass fibers.

In some embodiments, the glass fibers have an average length of from 3 mm to 50 mm. In some such embodiments, the glass fibers have an average length of from 3 mm to 10 mm, from 3 mm to 8 mm, from 3 mm to 6 mm, or from 3 mm to 5 mm. In alternative embodiments, the glass fibers have an average length of from 10 mm to 50 mm, from 10 mm to 45 mm, from 10 mm to 35 mm, from 10 mm to 30 mm, from 10 mm to 25 mm or from 15 mm to 25 mm.

In some embodiments, the glass fibers have generally an equivalent diameter of from 5 to 20 μm, preferably of from 5 to 15 μm, more preferably of 5 to 10 μm.

All glass fiber types, such as A, C, D, E, M, R, S, T glass fibers (as described in chapter 5.2.3, pages 43-48 of Additives for Plastics Handbook, 2nd edition, John Murphy), or any mixtures thereof may be used. E, R, S and T glass fibers are well known in the art. They are notably described in Fiberglass and Glass Technology, Wallenberger, Frederick T.; Bingham, Paul A. (Eds.), 2010, XIV, chapter 5, pages 197-225. R, S and T glass fibers are composed essentially of oxides of silicon, aluminium and magnesium. In particular, those glass fibers comprise typically from 62 to 75 wt % of SiO₂, from 16 to 28 wt % of Al₂O₃ and from 5 to 14 wt % of MgO. On the other hand, R, S and T glass fibers comprise less than 10 wt % of CaO.

The polyamide composition (PC) may further comprise at least one reinforcing agent which is different than the glass fibers and/or carbon fibers, as described above. A large selection of reinforcing agents, also called reinforcing fibers or fillers, may be added to the polyamide composition (PC). They can be selected from fibrous and particulate reinforcing agents.

A fibrous reinforcing filler is considered herein to be a material having length, width and thickness, wherein the average length is significantly larger than both the width and thickness. Generally, such a material has an aspect ratio, defined as the average ratio between the length and the largest of the width and thickness of at least 5, at least 10, at least 20 or at least 50. In some embodiments, the reinforcing fibers (e.g. carbon fibers) have an average length of from 3 mm to 50 mm. In alternative embodiments, the reinforcing fibers have an average length of from 10 mm to 50 mm. The average length of the reinforcing fibers can be taken as the average length of the reinforcing fibers prior to incorporation into the polyamide composition or can be taken as the average length of the reinforcing fiber in the polyamide composition.

A particulate reinforcing agent may be selected from mineral fillers (such as talc, mica, kaolin, calcium carbonate, calcium silicate, magnesium carbonate), graphene, nano-graphene, carbon nanotube, and glass balls (e.g. hollow glass microspheres).

In a particular embodiment, the polyamide composition (PC) includes nano-graphene and/or carbon nanotube as a reinforcing agent.

In another particular embodiment, the polyamide composition (PC) includes at most 3 wt % of nano-graphene and/or carbon nanotube based upon the total weight of the polyamide composition (PC) in addition to the glass fibers and/or carbon fibers as reinforcing agents.

In some embodiments, the polyamide composition (PC) excludes a reinforcing agent which is different from the glass fiber, as described above.

In some embodiments, the polyamide composition (PC) excludes glass spheres or balls and in particular excludes hollow glass balls.

In a particular embodiment, the polyamide composition (PC) comprises at least one non-metallic reinforcing agent. In another embodiment, the reinforcing agent is non-metallic.

In a more particular embodiment, the non-metallic reinforcing agent is selected from the group consisting of mineral fillers, glass fibers, carbon fibers, synthetic polymeric fibers, aramid fibers, aluminum fibers, titanium fibers, magnesium fibers, boron carbide fibers, rock wool fibers, steel fibers, natural fibers, graphene, nano-graphene, carbon nanotube, wollastonite and any combination of two or more thereof, preferably carbon fibers and/or glass fibers.

### Additive(s)

The polyamide composition (PC) comprises at least one additive, which is different from the reinforcing agent, in an amount of from 0 wt % to 30.0 wt % relative to the total weight of polyamide composition.

The additive may more particularly be selected from the group consisting of lubricants such as linear low density polyethylene, calcium stearate, magnesium stearate or sodium montanate; plasticizers; flame retardants, such as halogen and halogen-free flame retardants; nucleating agents; heat stabilizers; light stabilizers; antioxidants; processing aids; fusing agents; electromagnetic absorbers; tougheners; antistatic agents; impact modifiers; anti-blocking additive; slip additives; antifogging additives; chemical blowing agents, and any combinations thereof.

In a particular embodiment, the additive is selected from the group consisting of colorants, dyes, pigments, lubricants, plasticizers, flame retardants, nucleating agents, heat stabilizers, light stabilizers, antioxidants, processing aids, fusing agents, electromagnetic absorbers and any combinations thereof.

In a particular embodiment, the additive is selected from the group consisting of colorants, dyes, pigments, lubricants, plasticizers, nucleating agents, heat stabilizers, light stabilizers, antioxidants, processing aids, fusing agents, electromagnetic absorbers and any combinations thereof.

In a preferred embodiment, the additive is comprised in an amount of at least 0.1 wt %, preferably at least 0.2 wt %, more preferably at least 0.4 wt %, most preferably at least 0.5 wt %, and/or of at most 30 wt %, preferably at most 25 wt %, more preferably at most 15 wt %, most preferably at most 10 wt %, based upon the total weight of the polyamide composition.

In a particular embodiment, the additive is comprised in an amount of from 0.1 wt % to 5 wt %, preferably from 0.2 wt % to 3 wt %, more preferably from 0.4 wt % to 2 wt %, most preferably 0.5 wt % to 1 wt %, based upon the total weight of the polyamide composition (PC).

### Preparation of the Polyamide Composition (PC)

The polyamide composition (PC) is prepared by mixing the components of the composition (PC), the polyamide (PA) and the mixture to be mixed being in the molten form.

Any melt-mixing apparatus may be used for this preparation. Suitable melt-mixing apparatus are, for example, kneaders, Banbury mixers, single-screw extruders and twin-screw extruders. These apparatus make it possible to obtain an homogeneous polyamide composition (PC)

Preferably, use is made of an extruder, notably fitted with means for dosing all the desired components to the extruder, either to the extruder's throat or to the melt.

The order of combining the components during melt-mixing is not particularly limited. In one embodiment, the components can be mixed in a single batch, such that the desired amounts of each of them are added together and subsequently mixed. In other embodiments, a first sub-set of components can be initially mixed together and one or more of the remaining components can be added to the mixture for further mixing.

The conditions of preparation of the compounds given in the experimental section may be followed and adapted to prepare the polyamide composition (PC) defined in the present invention.

### About the Polyamide (PA)

The polyamide (PA) comprises at least 90.0 mol % of recurring units R_{(PA1)} according to formula (V):

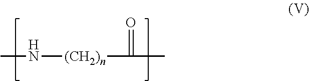

where n is 8 or 9.

According an embodiment, n is 8. According to another embodiment, n is 9.

The proportion of recurring units R_{(PA1)} is preferably at least 95.0 mol %, preferably at least 99.0 mol %, preferably at least 99.5 mol %, even preferably at least 99.9 mol %.

The proportion of recurring units R_{(PA1)} is most preferably 100 mol %.

In some embodiments, the polyamide (PA) further comprises at least 0.1 mol % of recurring units R_{(PA2)} and/or R_{(PA3)} according to formulae (VI) and (VII), respectively:

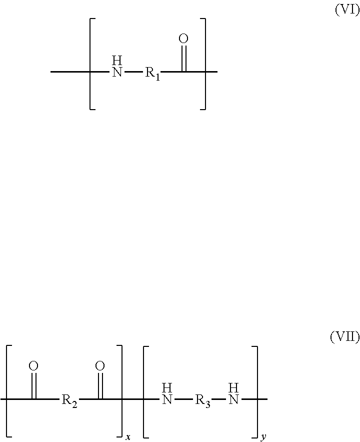

wherein:
   R₁ is a C₂-C₁₈ alkylene group;
   R₂ is selected from the group consisting of a C₂-C₁₈ alkylene group and a C₆-C₁₈ cycloalkylene group;
   R₃ is a C₄-C₁₈ alkylene group;
   x and y are 0 or 1, respectively; and
   the recurring unit R_{(PA2)} of formula (VI) is different from the recurring unit R_{(PA1)} of formula (V).

R₂ may more particularly be a C₂-C₁₈ alkylene group.

The alkylene groups in R₁, R₂ and R₃ are preferably of formula —(CH₂)ⱼ— where j is an integer respectively between 2 and 18; 2 and 18 or 4 and 18.

In one embodiment, x is zero and y is 1 such that recurring units R_{(PA3)} are recurring units of formula (VII-1):

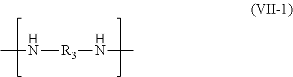

In another embodiment, x is 1 and y is zero such that recurring units R_{(PA3)} are recurring units of formula (VII-2):

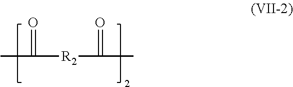

In a particular embodiment, the polyamide (PA) comprises at least 1.0 mol % of recurring units R_{(PA2)} and/or R_{(PA3)} according to formulae (VI) and (VII), respectively.

In another particular embodiment, the polyamide (PA) further comprises at least 3.0 mol % of recurring units R_{(PA2)} and/or R_{(PA3)} according to formulae (VI) and (VII), respectively.

In the present invention, the polyamide (PA) may comprise additional recurring units, distinct from recurring units (R_{PA2}) and (R_{PA3}).

The recurring units of the polyamide (PA) preferably consist of recurring units R_{(PA1)} and optionally of recurring units R_{(PA2)} and/or R_{(PA3)}. Most preferably, the recurring units of the polyamide (PA) consist preferably of recurring units R_{(PA1)}.

### Properties of the Polyamide (PA)

The polyamide (PA) has a number average molecular weight Mn (in g/mol) of at least 12,000, at least 13,000, at least 14,000, or at least 14,500. Mn is preferably at most 20,000 g/mol, preferably at most 18,000 g/mol. Depending on the molecular weight, the mechanical properties of a polyamide, e.g. tensile properties such as elongation at break substantially differ. For instance, in case the molecular weight is below 10,000, the elongation at break and also the melt viscosity would be too low to apply the polyamide in preparing an article or composite material by additive manufacturing. In addition, low melt viscosity of a polyamide may become a big obstacle in making a circular filament with a diameter of interest to be used in additive manufacturing.

Mn can be determined by Size Exclusion Chromatography (SEC). The conditions of D2 could be used: solvent of dissolution: hexafluoroisopropanol/0.01 N sodium trifluoroacetate; detector: refractive index.

Mn is preferably determined by Size Exclusion Chromatography (SEC) with the use of the following equation (1): Mn=2,000,000/[EG] (1) wherein [EG] is the proportion of end-groups in the PA expressed in mmol/kg. The proportions of end-groups may be determined by known analytical methods such as potentiometric methods for amine and/or acid end-groups or ¹H NMR for amide end-groups. See eg. Schröder, Elisabeth, Müller, Gert and Arndt, Karl-Friedrich. “1.2. Molecular Weight Determination by End Group Analysis”. Polymer Characterization, Berlin, Boston: De Gruyter, 1989, pp. 18-33 (https://doi.org/10.1515/9783112531846-003).

The elongation at break would be too low to apply the polyamide in manufacturing a smart device component if Mn <10,000 g/mol.

The polyamide (PA) has a melting point (Tm), as measured according to ASTM D3418, of at least 180° C., preferably at least 190° C., more preferably at least 200° C., and/or of at most 290° C., preferably at most 285° C., more preferably at most 280° C. Tm may be between 18° and 230° C.

The polyamide (PA) has a glass transition temperature (Tg), as measured according to ASTM D3418, of at least 20° C., preferably at least 30° C., more preferably at least 40° C., and/or of at most 200° C., preferably at most 190° C., more preferably at most 180° C. Tg may be between 35° C. and 80° C. or between 40° C. and 70° C., preferably between 40° C. and 60° C., more preferably between 40° C. and 50° C.

The polyamide (PA) has a heat of fusion (Hm), as measured according to ASTM D3418, of at least 5.0 J/g, preferably at least 7.0 J/g, more preferably at least 10.0 J/g, and/or of at most 80.0 J/g, preferably at most 70.0 J/g, more preferably at most 60.0 J/g.

In a preferred embodiment, the polyamide (PA) is bio-based. Under this embodiment, the polyamide (PA) exhibits a biobased content of at least 85.0%, the biobased content being expressed as the % of organic carbon of renewable origin in the polyamide (PA) and measured according to ASTM D6866-22. The biobased content is defined as the % of organic carbon of renewable origin. It corresponds to the amount of C calculated from measured ¹⁴C percent in the sample and corrected for isotopic fraction. A polymer having a biobased content of 100% has all its carbon atoms of a renewable origin.

The biobased content of the polyamide (PA) may preferably be at least 90.0%, preferably at least 95.0%. The biobased content of the polyamide (PA) may preferably be between 90.0 and 100% and preferably, it is 100%.

The polyamide (PA) and the polyamide composition generally have a water uptake, as measured by ASTM D570-98, of less than 2% after 24 hours and less than 3% after 60 days immersion at 23° C.

The polyamide (PA) may exhibit one or more of the following properties:
a tensile strength measured according to ISO 527-1, between 40 and 70 MPa, preferably between 50 and 60 MPa; and/or
a tensile modulus measured according to ISO 527-1, between 800 and 1400 MPa, preferably between 1000 and 1200 MPa; and/or
flexural strength measured according to ISO 178, between 50 and 90 MPa, preferably between 60 and 80 MPa; and/or
a flexural modulus measured according to ISO 178, between 1200 and 1900 MPa, preferably between 1300 and 1800 MPa;
a heat deflection measured according to ISO 75 (0.45 MPa) of 100° C. or more.

The polyamide (PA) may notably exhibit all these properties.

The conditions of preparation to prepare the polyamide (PA) exhibiting these properties are given in EP 3872116 (D2).

### End-Groups of the Polyamide (PA)

The end-groups of the polyamide (PA) are selected in the group of —NH₂, —COOH and amide end-groups. Indeed, the end-groups in the polyamide (PA) may be —NH₂ or —COOH. Yet, when the polycondensation involves the addition of an end-capping agent, these end-groups may be converted, partially or totally, into amide end-groups.

The amide end groups are of formula —NH—C(═O)—R where R is an alkyl group, an aryl group or a cycloalkyl group and/or of formula —C(═O)—NH—R′ where R′ is an alkyl group or a cycloalkyl group. R is more particularly a linear or branched C₂-C₁₈ alkyl group or a C₅-C₁₀ cycloalkyl group. R′ is more particularly a linear or branched C₂-C₁₈ alkyl group.

The amide end groups of formula —NH—C(═O)—R result from the reaction of the end-groups —NH₂ with a monocarboxylic acid (end-capping agent) of formula R—COOH.

The monocarboxylic acid (end-capping agent) may advantageously be selected in the group consisting of benzoic acid; cyclohexanoic acid; R—COOH where R is a linear or branched C₂-C₁₈ alkyl group and combination of two or more of these acids. R is the radical derived from the acid of formula R—COOH.

The monocarboxylic acid (end-capping agent) may more particularly be selected in the group consisting of acetic acid, propanoic acid, butyric acid, valeric acid, caproic acid, lauric acid, stearic acid, 2-ethylhexanoic acid, cyclohexanoic acid, benzoic acid and combination of two or more of these acids.

The monocarboxylic acid (end-capping agent) is more particularly of formula CH₃—(CH₂)ₘ—COOH where m is an integer between 0 and 16. The amide end groups are then of formula —NH—C(═O)—(CH₂)ₘ—CH₃.

The amide end groups of formula —C(═O)—NH—R′ result from the reaction of the end-groups-COOH with a primary amine (end-capping agent) of formula R′—NH₂.

The primary amine (end-capping agent) may advantageously be selected in the group consisting of the amines of formula R′—NH₂ where R′ is a linear or branched C₂-C₁₈ alkyl group. R′ is the radical derived from the amine of formula R′—NH₂.

The primary amine (end-capping agent) is more particularly of formula CH₃—(CH₂)_{m′}—NH₂ where m′ is an integer between 2 and 18. The amide end groups are then of formula —C(═O)—NH—(CH₂)_{m′}—CH₃.

The primary amine (end capping agent) may more particularly be selected in the group consisting of propyl amine, butylamine, pentylamine, hexylamine, 2-ethylhexylamine, n-octylamine, n-dodecylamine, n-tetradecylamine, n-hexadecylamine, stearylamine, cyclohexylamine and combination of two or more of these amines.

The proportion of the end groups can be quantified by 1H NMR or by potentiometric techniques.

### Preparation of the Polyamide (PA)

The polyamide (PA) is prepared by polycondensation.

The polyamide (PA) is prepared by polycondensation by heating a reaction mixture (RM) comprising:
an amino acid component comprising the amino acid of formula (I): NH₂—(CH₂)ₙ—COOH (I) wherein n is 8 or 9;
optionally a diamine component comprising at least one diamine of formula (III) H₂N—R₂—NH₂ (III) where R₂ is as disclosed herein;
optionally a dicarboxylic acid component comprising at least one dicarboxylic acid of formula (IV) HOOC—R₃—COOH (IV) where R₃ is as disclosed herein;
optionally an amino acid comprising at least one aminoacid NH₂—R₁—COOH (II) different from the aminoacid of formula (I) where R₁ is as disclosed herein.

The reaction mixture (RM) preferably does not comprise a cyclic monomer.

Biobased aminoacid(s) of formula (I) may be used to prepare the polyamide (PA) having a biobased content. Thus, oleic acid, a fatty acid that occurs naturally in various natural resources, may be used as a starting material to produce 9-aminopelargonic acid, i.e. 9-aminononanoic acid. Such bio-based oleic acid undergoes oxidative cleavage to produce pelargonic acid and azelaic acid, of which the latter is subject to nitrilation and then hydrogenation to obtain 9-aminopelargonic acid. Similarly, ricinoleic acid, a fatty acid that occurs naturally in various natural resources, may be used as a starting material to produce 10-aminodecanoic acid. Such bio-based ricinoleic acid can be hydrolyzed with caustic soda to produce 2-octanol or capryl alcohol and sebacic acid. Other routes like oxidative cleavage, ozonolysis, fermentation, etc. of ricinoleic acid yield sebacic acid and various by products. For example, nitrilation of the sebacic acid, followed by hydrogenation delivers 10-aminodecanoic acid. US 2011/0105774 A1 (Arkema France) also discloses a process of preparing 9-aminononanoic acid or its esters from natural unsaturated fatty acids. Biobased 9-aminopelargonic acid and 10-aminodecanoic acid are also available on the market.

The diamine component includes all the diamines in the reaction mixture (RM) that polycondense with the dicarboxylic acid(s) or amino acid(s) in the reaction mixture (RM) to form the recurring units of the polyamide (PA). Similarly, the dicarboxylic acid component includes all the dicarboxylic acids in the reaction mixture (RM) that polycondense with the diamine(s) or amino acid(s) in the reaction mixture. Further, the amino acid component includes all of the amino acids in the reaction mixture (RM) that polycondense with the diamine(s), the dicarboxylic acid(s) or the amino acid(s) in the reaction mixture.

In the reaction mixture (RM), the proportions of diamines, dicarboxylic acids and amino acids are such as to obtain the desired final composition of the polyamide (PA). The initial proportions of acid-COOH and amine groups —NH₂ from the monomers in the reaction mixture (RM) is generally such that the molar ratio [—COOH]/[—NH₂] is from 0.9 to 1.1, preferably from 0.95 to 1.07, more preferably 1.00 to 1.05, where [—COOH] and [—NH₂] are the initial number of moles of —NH₂ and —COOH groups from the monomers in the reaction mixture (RM).

The reaction mixture (RM) also preferably comprises a catalyst, for instance a catalyst containing at least an atom of phosphorus such as sodium hypophosphite or phosphoric acid.

The reaction mixture (RM) must be heated at a high temperature, preferably up to a temperature of at least Tm+10° C., Tm being the melting temperature of the polyamide. The temperature at which the concensation is performed is usually at least 200° C.

The polycondensation is advantageously performed in the melt, notably in the absence of a solvent.

The polycondensation is advantageously performed in a well stirred vessel such as a stirred reactor. The vessel is also advantageously equipped with means to remove the volatile products of reaction. One can conveniently use a stirred vessel to perform the polycondensation.

The conditions disclosed in the experimental section for the preparation of PA9 may be followed and adapted to the composition of polyamide (PA). The experimental conditions disclosed in examples 1 or 2 of EP 3872116 A1 may also be followed and adapted to the composition of polyamide (PA).

Non-limitative examples of suitable amino acids of formula (I) are notably 6-amino-hexanoic acid, 11-aminoundecanoic acid and 12-aminododecanoic acid.

Non-limitative examples of dicarboxylic acids of formula (IV) are notably malonic acid, succinic acid, glutaric acid, 2,2-dimethyl-glutaric acid, adipic acid, 2,4,4-trimethyl adipic acid, pimelic acid, suberic acid, sebacic acid, undecanedioic acid and dodecandioic acid.

Non-limitative examples of diamines of formula (III) are notably 1,2-diaminoethane, 1,2-diaminopropane, propylene-1,3-diamine, 1,3-diaminobutane, 1,4-diaminobutane, 1,5-diaminopentane, 1,5-diamino-2-methylpentane, 1,4-diamino-1,1-dimethylbutane, 1,4-diamino-1-ethylbutane, 1,4-diamino-1,2-dmethylbutane, 1,4-diamino-1,3-dimethylbutane, 1,4-diamino-1,4-dimethylbutane, 1,4-diamino-2.3-dimethylbutane, 1,2-diamino-1-butylethane, 1,6-diaminohexane, 1,7-diaminoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, 1,9-diaminononane, 1,6-diamino-2,2,4-trimethylhexane, 1,6-diamino-2,4,4-trimethylhexane, 1,7-diamino-2,3-dimethylheptane, 1,7-diamino-2,4-dimethylheptane, 1,7-diamino-2,5-dimethylheptane, 1,7-diamino-2,2dimethylheptane, 1,10-diaminodecane, 1,8-diamino-1,3-imethyloctane, 1,8-diamino-1,4-1,8-diamino-2,4-dimethyloctane, 1,8-diamino-3,4-dimethyloctane, dimethyloctane, 1,8-diamino-2,2-1,8-diamino-4,5-dimethyloctane, dimethyloctane, 1,8-diamino-3,3-dimethyloctane, 1,8-diamino-4,4-dimethyloctane, 1,6-diamino-2,4-diethylhexane, 1.9-diamino-5-methylnonane, 1,11-diaminoundecane, 1,12-diaminododecane and 1,13-diaminotridecane.

### Experimental Section

### Raw Materials

The raw materials used to form the samples as provided below:
PA9: see synthesis details below
PA510: commercially available from Cathay
PA610: commercially available from Radici (Radipol® DC45)
PA12: commercially available from Evonik (Vestamid® L1700)
Glass Fiber: FFE glass fiber (J834, CS G3PA-820), from Nittobo
Other Additives: a lubricant (calcium stearate Ceasit I from Baerlocher), a UV stabilizer (Chimassorb®944 LD from BASF), a UV light absorber (Tinuvin®234 from BASF) and a heat stabilizer (Irganox® B1171 from BASF)

Preparation of PA9: a stirred batch vessel was charged with 2,425 g of 9-aminopelargonic acid (19.3 mol) and 0.736 g of sodium hypophosphite (7 mmol). The reaction mixture was heated to 230° C. and kept at this temperature for 45 min. During this phase, 221 g of water was distilled. The pressure was then reduced to 600 mBar and held in these conditions for 120 min. 55 g of water was recovered. The reactor was brought back to atmospheric pressure and the polyamide was downloaded and pelletized. 1,505 g of PA9 was recovered. Melt polycondensation of the 9-amino nonanoic acid in an autoclave yielded the PA9 with a molecular weight of 15,300 g/mol.

PA10 could be prepared following the same recipe starting with 10-aminodecanoic acid.

Compounding of PA compositions: polyamides were then compounded with 55 wt % of FFE glass fiber, 0.1 wt % of calcium stearate, 0.2 wt % of Irganox® B1171, 0.3 wt % of Chimassorb® 944LD and 0.15 wt % of Tinuvin® 234, using a ZSK-26 extruder with a temperature profile up to 270° C. The compounds (polyamide compositions (PC)) were then molded into tensile bars (‘samples’).

### Test Methods & Results

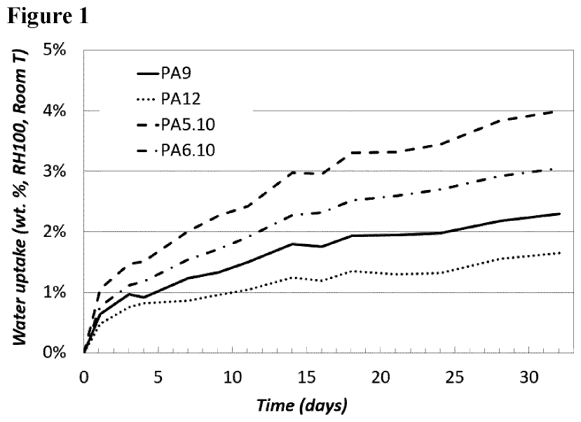

Water Uptake (ASTM D570-98): samples were soaked in water (100% RH) at room temperature (23° C.) and their weight was measured at pre-determined intervals to determine the amount of water that was absorbed. The water uptake of PA9 was lower than (fully bio-based) PA510 and even than (partially bio-based) PA610. The water uptake (in %) in 4, 11, 18, 28 and 32 days is described in Table 1 below and also shown in FIG. 1.

TABLE 1

| (in %) | 4 days | 11 days | 18 days | 28 days | 32 days |
|---|---|---|---|---|---|
| PA9 | 0.92 | 1.50 | 1.94 | 2.18 | 2.29 |
| PA12 | 0.82 | 1.04 | 1.35 | 1.55 | 1.65 |
| PA510 | 1.50 | 2.43 | 3.30 | 3.84 | 3.99 |
| PA610 | 1.18 | 1.91 | 2.52 | 2.92 | 3.05 |

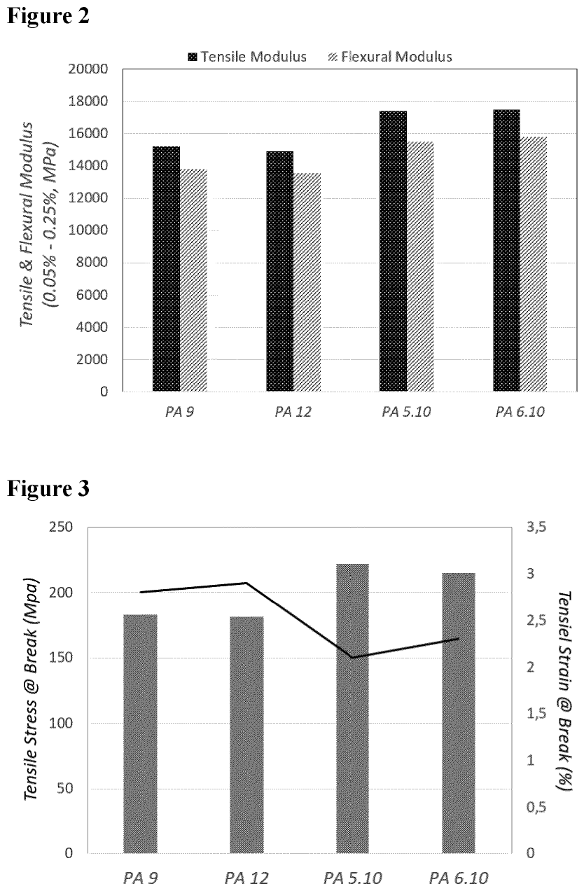

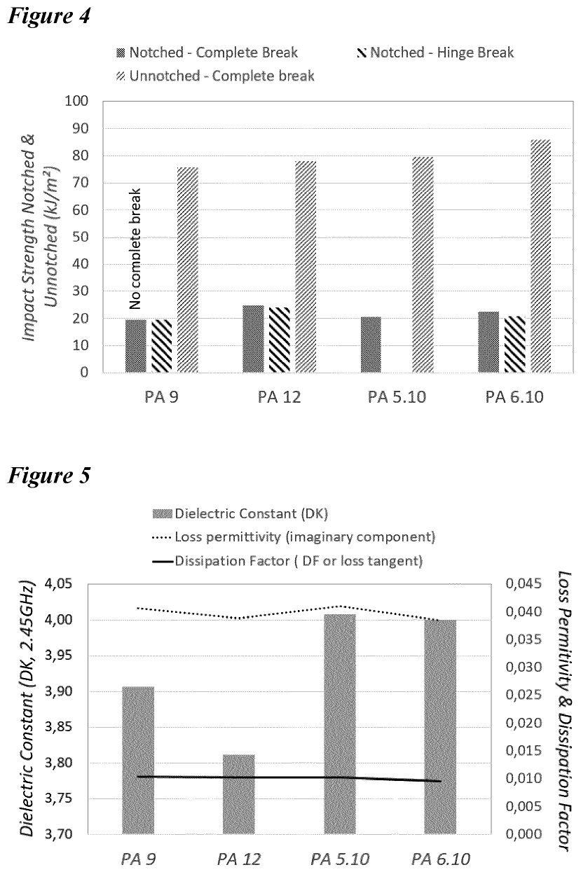

Melting point (ASTM D3418): The melting point of PA9 was measured as about 207° C. similar to PA510 (212° C.), which was higher than PA12 by about 25° C. (Tm of PA12: about 182° C.).
Mechanical properties were evaluated on dry as molded (DAM) bars, according to the corresponding standards. Overall, the mechanical properties of PA9 were comparable to PA12, PA510 and PA610, and notably with regard to the impact strength (both notched and unnotched), no breakage was observed with PA9 sample only during the whole evaluation process, which confirms the good ductility of PA9.
   Tensile & Flexural moduli (ISO178) (see FIG. 2);
   Tensile stress & strain (ISO527) (see FIG. 3); and
   Impact strength: Notched & Unnotched Izod (ISO180) (see FIG. 4).
Dimensional stability was also evaluated by mold shrinkage (ISO294). Mold shrinkage of PA9 was comparable to that of PA610, though PA12 and PA510 exhibited better mold shrinkage than PA9.
Dielectric properties (dielectric constant & dissipation factor): Dielectric constant of PA9 was higher than that of PA12 (typical of long chain polyamides), while PA510 and PA610 showed much higher dielectric constants (see FIG. 5).

TABLE 2

| Properties | PA9 | PA12 | PA510 | PA610 |
|---|---|---|---|---|
| Moisture absorption (water uptake) | + | + | − | − |
| Dimensional stability | + | + | − | − |
| Dielectric properties | + | + | − | − |
| Mechanical properties (DAM) | + | + | + | + |
| Thermal stability | + | − | + | + |
| (for PVD process) | | | | |

+ = favorable performance;
− unfavorable performance

As shown in Tables 1 and 2, only PA9 exhibited favorable performance in all properties measured. These results suggest that PA9 can be used to effectively enhance the dimensional stability thanks to its low water uptake, while maintaining excellent mechanical properties and thermal stability of the polyamide composition.

1. A Smart device including at least one smart device component comprising a polyamide composition (PC) which consists of:
at least 50.0 wt % of at least one polyamide (PA) comprising at least 90.0 mol % of recurring units R_{(PA1)} according to formula (V): 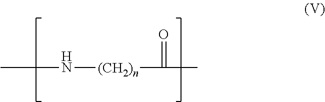
from 0 wt % to 50.0 wt % of at least one reinforcing agent, selected from the group consisting of mineral fillers, glass fibers, carbon fibers, synthetic polymeric fibers, aramid fibers, aluminum fibers, titanium fibers, magnesium fibers, boron carbide fibers, rock wool fibers, steel fibers, natural fibers, graphene, nano-graphene, carbon nanotube, wollastonite, glass balls and any combination of two or more thereof; and
from 0 wt % to 30.0 wt % of at least one additive, selected from the group consisting of lubricants, calcium stearate, magnesium stearate or sodium montanate; plasticizers; flame retardants; nucleating agents; heat stabilizers; light stabilizers; antioxidants; processing aids; fusing agents; electromagnetic absorbers;
tougheners; antistatic agents; impact modifiers; anti-blocking additive; slip additives; antifogging additives; chemical blowing agents and any combination of two or more thereof;
wherein:
n is 8 or 9;
wt % is relative to the total weight of the polyamide composition (PC); and
mol % is relative to the total moles of recurring units in the polyamide (PA).

2. The Smart device according to claim 1, including at least one battery.

3. The Smart device according to claim 1, wherein the smart device is selected from the group consisting of a mobile electronic phone, a smart phone; a personal digital assistant; a laptop computer; a tablet computer; a radio; a camera and camera accessories; a wearable computing device, a smart watch, smart glasses, a calculator, a music player, a global positioning system (GPS) receiver, a portable game console and console accessories, a hard drive and electronic storage devices.

4. (canceled)

5. (canceled)

6. The Smart device according to claim 1, wherein the smart device component is selected from the group consisting of antenna windows, fitting parts, snap fit parts, mutually moveable parts, functional elements, operating elements, tracking elements, adjustment elements, carrier elements, frame elements, switches, connectors, cables, housings, speaker parts, and any other structural part other than housings as used in a mobile electronic devices.

7. (canceled)

8. The Smart device according to claim 1, wherein the components of the polyamide composition (PC) are blended together.

9. The Smart device according to claim 1, wherein the proportion of recurring units R_{(PA1)} in the polyamide (PA) is at least 95.0 mol %.

10. The Smart device according to claim 1, wherein the recurring units of the polyamide (PA) consist of recurring units R_{(PA1)}.

11. The Smart device according to claim 1, wherein the polyamide (PA) comprises at least 0.1 mol % of recurring units R_{(PA2)} and/or R_{(PA3)} according to formulae (VI) and (VII), respectively: 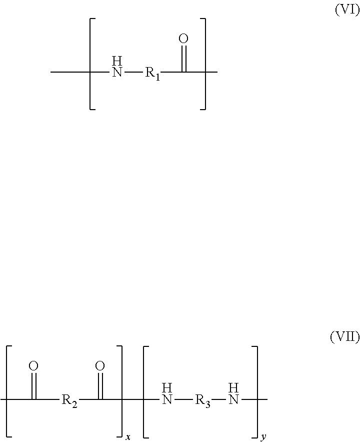
wherein:
R₁ is a C₂-C₁₈ alkylene group;
R₂ is selected from the group consisting of a C₂-C₁₈ alkylene group and a C₆-C₁₈ cycloalkylene group;
R₃ is a C₄-C₁₈ alkylene group;
x and y are 0 or 1, respectively; and
the recurring unit R_{(PA2)} of formula (VI) is different from the recurring unit R_{(PA1)} of formula (V).

12. The Smart device according to claim 11, wherein the recurring units of the polyamide (PA) consist of recurring units R_{(PA1)} and recurring units R_{(PA2)} and/or R_{(PA3)}.

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. The Smart device according to claim 1, wherein the reinforcing agent in the polyamide composition (PC) is selected from the group consisting of glass fibers, carbon fibers and combinations thereof.

25. A Smart device component selected from the group consisting of antenna windows, fitting parts, snap fit parts, mutually moveable parts, functional elements, operating elements, tracking elements, adjustment elements, carrier elements, frame elements, switches, connectors, cables, housings, speaker parts, and any other structural part other than housings as used in a mobile electronic devices wherein the component comprises the polyamide composition (PC) as defined in claim 1.

26. The Smart device component of claim 25, which is a smart device housing or an antenna window.

27. A method comprising manufacturing a smart device component selected from the group consisting of antenna windows, fitting parts, snap fit parts, mutually moveable parts, functional elements, operating elements, tracking elements, adjustment elements, carrier elements, frame elements, switches, connectors, cables, housings, speaker parts, and any other structural part other than housings as used in a mobile electronic devices from the polyamide composition (PC) according to claim 1.

28. The method according to claim 27, wherein the smart device component is a smart device housing.
